(19) United States
(12) Patent Application Publication
(10) Pub. No.: US 2007/0294092 A1
(43) Pub. Date: Dec. 20, 2007

(54) System and method for creating and organizing job applicant credential information

(75) Inventor: Jeffrey Calannio, Laguna Niguel, CA (US)

Correspondence Address: JAFARI LAW GROUP, P.C., 801 N. PARKCENTER DRIVE, SUITE 220, SANTA ANA, CA, 92705, US

(73) Assignee: MyCredententials, Inc.

(21) Appl. No.: 11/453,602

(22) Filed: Jun. 15, 2006

(51) Int. Cl. G06Q 10/00

(52) U.S. Cl. 705/1

(57) ABSTRACT

The invention is a system and method for creating and organizing credential information comprising a server, a memory module, a database, and a user interface wherein users can store and organize comprehensive credential information, such as testimonials written about said user, multimedia presentations authored by said user, job ideals, and indicators of said user's personality. The user can target portal views of important information, customize the look and feel of portal views, and can create customized advertisements to be shown to prospective hiring parties. Further, prospective hiring parties can easily search the database through customized filters and easily browse through comprehensive information in a time-saving manner.

### TECHNICAL FIELD OF THE INVENTION

The present invention relates generally to system and method for organizing credential information and presenting that information to prospective hiring parties. This system enables a user, for example a job applicant, to use a network and database as a tool for creating, displaying, and organizing a career portal which enables other users, for example prospective hiring parties, to search, access and review information displayed accurately and efficiently.

### BACKGROUND OF THE INVENTION

Traditionally, a resume has been the main initial means of communication between a job applicant and a prospective hiring party. Originally, a resume was prepared on paper and submitted by hand to the prospective hiring party, by mail to a placement agency, or directly to the human resource department of a company. The rise in computer use led to the sending and acceptance of resumes via email. After the advent of the Internet, online job recruiting sites allowed for the posting of job applicant resumes and employer job openings.

Although technology surrounding the writing and dissemination of resumes has advanced, the traditional text based resume format has not. Resumes are usually one page, or sometimes two pages if more experience needs to be included. Traditional resumes only highlight job applicants' experiences, achievements, and education. Employers and recruiters may receive hundreds or thousands of responses to a job opening over a two to three month period. Each resume, therefore, can only be reviewed briefly. A short resume will most likely be read in its entirety but important information will most likely be left off the resume. The information of interest to a hiring party may be difficult to find or may be misleading due to the brevity required by resumes. Even a long resume, which may contain more key information, will most likely not be read in its entirety and still may not contain all the potential key information that the job applicant desires to demonstrate, or the prospective hiring party desires to know.

The resume format itself is the problem. A need exists for a format that allows a user, such as a job applicant, to provide more information regarding the user's qualifications and credentials to a prospective hiring party. A need exists for applicants to present their credentials to a prospective hiring party in a format and presentation that goes beyond traditional resume categories to provide a broader and more complete view of the applicant's abilities. A need also exists for prospective hiring parties to access this additional information about applicants, allowing far more insight and depth to adequately match available positions, without sacrificing time and money.

Therefore, it is desirable to have a system and method that provides a more focused search of the needs of a hiring party while enhancing accuracy, enhancing efficiency, and minimizing the high costs required through other existing methods.

### SUMMARY OF THE INVENTION

To minimize the limitations in the prior art, and to minimize other limitations that will be apparent upon reading and understanding the present specification, the present invention provides a system and method for organizing credential information, for example job applicant data, for consideration by a prospective hiring party.

A system in accordance with the present invention comprises a server, a memory module accessible by the server, a database, including a data repository for each job applicant stored in the system, and a communication link connecting the server to a user interface.

Each data repository includes a unique identifier and at least one data object. The user interface enables the user to input data into data objects in an associated repository, which contains a unique identifier assigned to the user and provides the user with tools to select a subset of data objects in the data repository. Additionally, the user can arrange a subset of data objects in at least one customized portal view.

A method in accordance with the present invention includes the steps of assigning a unique identifier to a user, providing a database within which to store data objects, creating a data repository in said database, including a unique identifier and associated data objects, and prompting said user to input data into at least one data object in the data repository.

It is an object of the present invention to allow users, for example job applicants, to provide as much comprehensive information about themselves as possible to interested prospective hiring parties, which no other resume or known resume system has provided before.

It is another object of the present invention to allow users to provide personalized multimedia content, such as multimedia audio or video presentations to provide a prospective hiring party with information about a user's physical personality (i.e. appearance, presence).

It is still another object of the invention to allow users to provide personal advertisements of themselves to prospective hiring parties with links to comprehensive information.

It is still another object of the invention to allow users to provide an updated schedule for prospective hiring parties to know availability information such as when the user is available for interviews and work.

It is still another object of the invention to facilitate users and prospective hiring parties to schedule and perform live interviews through the system from conveniently located user interfaces.

It is still another object of the invention to allow users to create customized portal views of their comprehensive information, creating a look and feel that would attract potential hiring parties compatible with their personality, targeting specific industries or targeting specific prospective hiring parties.

It is still another object of the invention to allow similarly situated users to interact with each other to create a network of professional groups.

It is still another object of the invention to allow a prospective hiring party to provide intuitive browsing options for a prospective hiring party to easily browse through user's comprehensive information.

It is still another object of the invention to categorize different job credentials in logically efficient and separable categories to facilitate potential hiring parties' efforts to browse targeted information.

It is still another object of the invention to allow a prospective hiring party to create their own portal view of a user's comprehensive information to focus on the information of paramount importance.

It is still another object of the invention to allow a prospective hiring party to create ever expansive portal views of a user's comprehensive information as the prospective hiring party requests more detailed information on potential applicants.

These and other advantages and features of the present invention are described herein with specificity so as to make the present invention understandable to one of ordinary skill in the art.

### BRIEF DESCRIPTION OF THE DRAWINGS

Referring now to the drawings in which like reference numbers represent corresponding parts throughout:

FIG. 1 illustrates a block diagram of a user credential information system in accordance with the present invention.

FIG. 2 is an exemplary embodiment of server 110 of FIG. 1 in accordance with practice of the present invention.

FIG. 3 illustrates an exemplary embodiment of a database in accordance with the present invention.

FIG. 3(a) illustrates a portal view of a user's database repository in accordance with the present invention.

FIG. 3(b) illustrates a portal view of a user's database repository in accordance with the present invention

FIG. 4 is a flow chart illustrating a method for a user to input and organize applicant information in accordance with the present invention.

FIG. 5 is a flow chart illustrating a method for a prospective hiring party to access applicant information in accordance with the present invention.

FIG. 6 is a flow chart illustrating a method for creating, editing and viewing data objects and data object types in accordance with the present invention.

FIG. 7 illustrates an exemplary embodiment of a site map to a website provided by the server in accordance with the present invention.

FIG. 8 illustrates an exemplary embodiment of a portal view of a job applicant's comprehensive information in accordance with the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the invention.

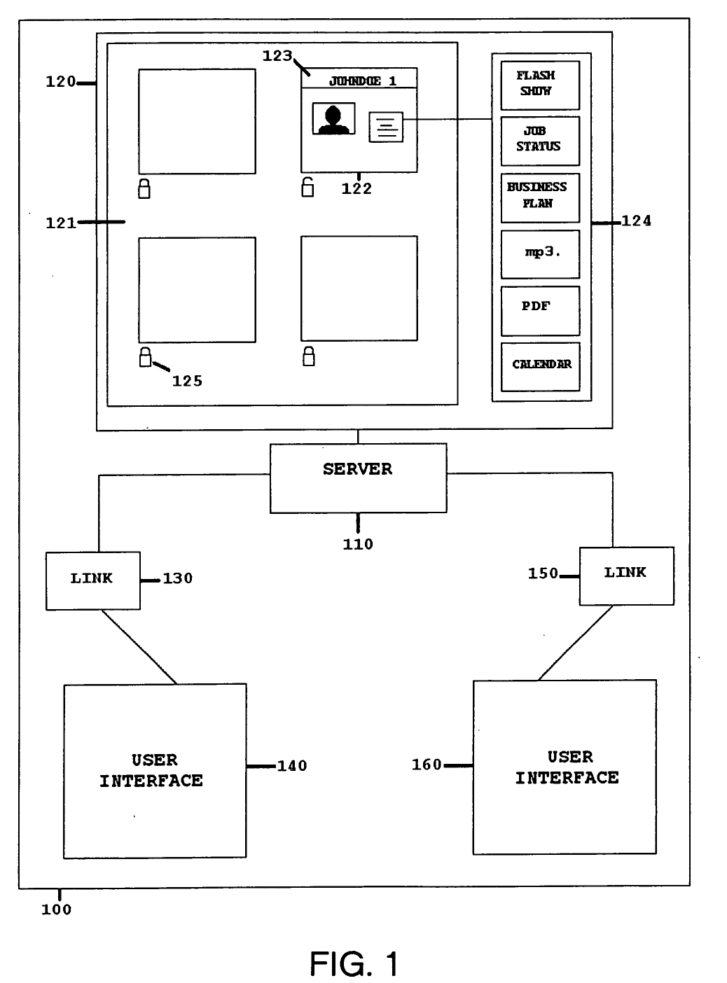

FIG. 1 illustrates a block diagram of the system in accordance with the present invention. This figure shows the system's major components and their interrelationships. FIG. 1 also shows components of the system that enable individual users, for example job applicants, to create, edit, and access data stored within the system. Additionally, FIG. 1 also shows components of the system that enable other users, for example prospective hiring parties, to search and view various data objects stored within system 100. For the purpose of this invention, a “job applicant” refers to any user of system 100 who wishes to create an applicant repository on database 121, and a “prospective hiring party” is any user who wishes to access information database 121 for the purpose of evaluating at least one job applicant for a potential job. Each of the components and embodiments thereof are described in detail below.

System 100 is shown in FIG. 1, with server 110, memory module 120, database 121, data repository 122, unique identifier 123, data objects 124, security lock 125, job applicant communication link 130, job applicant user interface 140, prospective hiring party communication link 150, and prospective hiring party user interface 160. Although system 100 is shown as six physically separate components, system 100 can be implemented on a single computer system, or several computer systems without departing from the scope of the present invention.

Server 110 can be a minicomputer, a microcomputer, a UNIX™ machine, a mainframe computer, an Intel™ machine, an Apple™ machine, a PowerPC™ machine, or any other appropriate computer without departing from the scope of the present invention. In an exemplary embodiment, server 110 is a distributed server system set up for robustness in case one server fails. In another exemplary embodiment, server 110 is a World Wide Web (WWW) server connected to the internet.

As shown, memory module 120 is attached either externally or internally to server 110. Memory module 120 is typically a long term memory storage device, such as a hard drive, disk drive, tape unit, Network Attached Storage (NAS) device, Storage Attached Network (SAN) device, RAID disk array, or optical disk array. Although typically a long term memory storage device, memory module 120 can be any other memory device, such as RAM or a floppy disk, without departing from the scope of the present invention. In an exemplary embodiment, memory module 120 is striped across a RAID disk array in a SAN environment for increased data access speeds and robustness.

Database 121 holds data objects within data repositories collected by job applicant system 100, and is stored on memory module 120. Database 121 is typically created by a known database manager using known technologies such as relational architecture and SQL access, such as Microsoft™ SQL or Oracle™ DB. However, database 121 can be as simple as a series of files stored in a directory, with a text file listing filename locations without departing from the scope of the present invention. In one embodiment, database 121 is a combination of a known database manager, and an organized directory tree structure, wherein the database manager stores text information in the database itself, but stores multimedia information and other non-text information as filename locations of files stored in an organized directory tree structure.

Database 121 holds multiple data repositories 122, wherein each repository corresponds to a separate job applicant. Database 121 is organized around a unique identifier 123 as a database key, one for each data repository 122. Each data repository comprises at least one data object 124.

For example and in no way limiting the scope of the present invention, in the illustrated embodiment, data repository 122 corresponds to a specific job applicant, whose unique identifier 123 is “JOHNDOE1.” All data objects 124 of said job applicant are associated with unique identifier 123 “JOHNDOE1” in data repository 122. When the job applicant associated with “JOHNDOE1” creates a calendar illustrating availability times and dates for said job applicant, and an audio file in mp3 format featuring an introduction created by said job applicant, these job applicant data objects are stored data repository 122.

In one embodiment of the invention, each data repository comprises a security lock 125. Security lock 125 will limit read access to the associated data objects 124 to users who possess the required security clearance. In one embodiment, security lock 125 is implemented organizationally in a security clearance system, where only prospective hiring parties in a designated security class can access a portal view. In an exemplary embodiment of the invention, security lock 125 is an alphanumeric password that job applicants can give to prospective hiring parties of the system to view a portal view (discussed below) of their information. In another embodiment, a job applicant can grant access to specific prospective hiring parties using system 100 identified by some unique identifier and deny access to other prospective hiring parties. In yet another embodiment, a job applicant can grant privileged access to a subset of prospective hiring parties by a category, such as granting access to companies, but removing access from recruiters and headhunters. In yet another embodiment, security lock 125 is implemented organizationally in a security clearance system, where only prospective hiring parties in a designated security class can access a portal view. Security lock 125 can limit access to a job applicant's portal view via other methods, without departing from the scope of the invention. An unlocked applicant repository 122 is shown keyed with the unique identifier 123 “JOHNDOE1.”

Job applicant user interface 140 is connected to server 110 via job applicant communication link 130. As stated above, for the purpose of this invention, a “job applicant” refers to any user of system 100 who wishes to create a data repository on database 121. Job applicant communication link 130 is typically an internet connection, but can also comprise a hard-wired connection, a telephone connection, a wireless connection, a Local Area Network (LAN) or Wide Area Network (WAN) connection, a combination of the preceding, or any other type of connection without departing from the scope of the present invention. In an exemplary embodiment, job applicant communication link 130 is the World Wide Web. In another exemplary embodiment, several job applicant user interfaces can connect to server 110 at the same time. In yet another exemplary embodiment, several job applicant user interfaces 140 can connect to server 110 using different types of job applicant communication links.

Job applicant user interface 140 enables bidirectional communication between a job applicant and server 110 via job applicant communication link 130. As shown, job applicant user interface 140 is typically a separate computer with a keyboard and a monitor. Job applicant user interface 140 can additionally be a monitor and keyboard physically connected to server 110 without departing from the scope of the invention. In one embodiment, job applicant user interface 140 is client software installed on a remote machine which communicates via a TCP/IP network with server 110. In an exemplary embodiment, job applicant user interface 140 is a website hosted by server 110 communicating through HTTP protocol. In yet another exemplary embodiment, job applicant user interface 140 is an AJAX (Asynchronous JavaScript and XML) application, exchanging small amounts of data with server 110 so that the entire website does not have to be reloaded each time the job applicant inputs data or requests data.

Job applicant user interface 140 enables a job applicant to input data into database 121, typically through a keyboard connected to a networked computer, although other methods can be utilized without departing from the scope of the invention.

In one embodiment, job applicant user interface 140 enables a job applicant to enter data into at least one data object 124 within the job applicant's associated data repository 120.

Job applicant user interface 140 additionally enables a job applicant to select a subset of data objects to publish in a portal view. In one embodiment, this portal view is published as a Uniform Resource Locator (URL) that a job applicant can give to anyone who has access to the internet. In another embodiment, this portal view is available within system 100 only to prospective hiring parties who have created an account on system 100 and are authenticated by system 100. In yet another embodiment, this portal view is available within system 100 only to prospective hiring parties who have created an account on system 100, are authenticated by system 100, and have appropriate security to unlock security clearance 125.

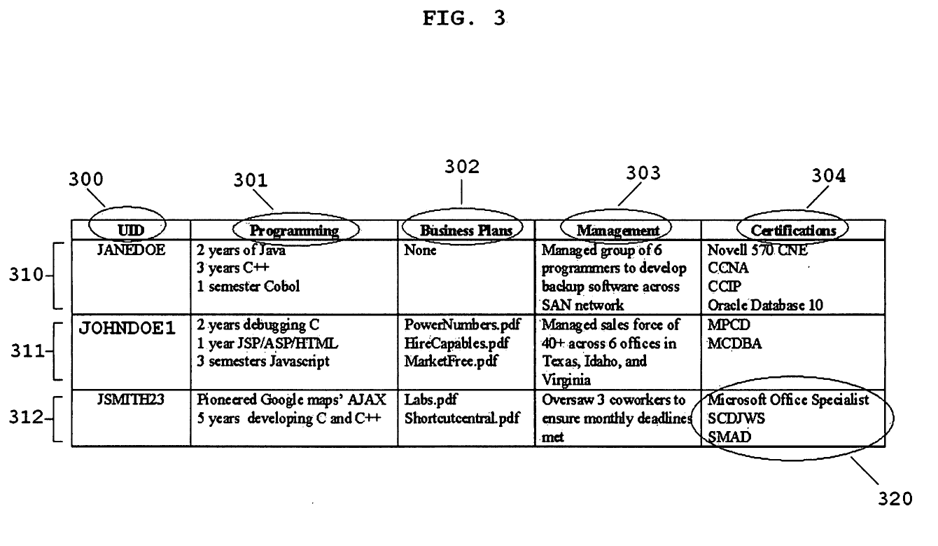

By creating such a portal view, a job applicant can create a focused online resume that only displays job applicant data objects that are paramount to a specific job field. For example and in no way limiting the scope of the present invention, a job applicant can create a first portal view targeting computer programming jobs, selecting primarily programming experience and hardware certifications, and a second portal view targeting management jobs, selecting primarily business plans and multi-person projects (see FIGS. 3(a) and 3(b)).

In another exemplary embodiment, job applicant user interface 140 enables a job applicant to activate security lock 125 that will prohibit non-privileged users of system 100 to view a published portal view, all data objects within a data repository, a particular data object within a data repository, or some combination thereof.

Prospective hiring party user interface 160 is connected to server 110 via prospective hiring party communication link 150. As mentioned above, for the purposes of this invention, a “prospective hiring party” is any user who wishes to access job applicant information from database 121 for the purpose of evaluating at least one job applicant for a potential job. Prospective hiring party communication link 150 is typically an internet connection, but can also comprise a hard wired connection, a telephone connection, a wireless connection, a Local Area Network (LAN) or Wide Area Network (WAN) connection, a combination of the preceding, or any other type of connection without departing the scope of the present invention. In an exemplary embodiment, communication link 150 is the World Wide Web. In another exemplary embodiment, communication link 150 allows several prospective hiring parties user interfaces to connect to server 110 at the same time. In yet another exemplary embodiment, several prospective hiring party user interfaces 160 can connect to server 110 using different types of prospective hiring party communication links (i.e. one through a LAN and one though a telephone connection).

Prospective hiring party user interface 160 enables bidirectional communication between a prospective hiring party and server 110 via prospective hiring party communication link 150. As shown, prospective hiring party user interface 140 is typically a separate computer with a keyboard and a monitor. Prospective hiring party user interface 160 can additionally be a monitor and keyboard physically connected to server 110 without departing from the scope of the invention. In one embodiment, prospective hiring party user interface 160 is client software installed on a remote machine that communicates via a TCP/IP network with server 110. In an exemplary embodiment, prospective hiring party user interface 160 is a remote website hosted by server 110 communicating through HTTP protocol. In another exemplary embodiment, prospective hiring party user interface 160 is an AJAX (Asynchronous JavaScript and XML) application, exchanging small amounts of data with server 110 so that the entire website does not have to be reloaded each time the prospective hiring party inputs data or requests data.

Prospective hiring party user interface 160 enables a prospective hiring party to input data for searches of database 121, typically through a keyboard, although other methods can be utilized without departing from the scope of the invention. In one embodiment, prospective hiring party user interface 160 enables a prospective hiring party to enter a search query. The search query can be an alphanumeric string, an SQL query, a Boolean query, or any other known method of searching a database, without departing from the scope of the present invention. Once the input procedure is completed, server 110 performs a search of all data objects in database 121, returning matched job applicants to the prospective hiring party. In an exemplary embodiment of the invention, the prospective hiring party can perform advanced searches, such as specifying which job applicant data object types to search, searching synonyms of words, or organizing search results by category. In yet another embodiment, the prospective hiring party can limit a search to only certain data object types, such as thesis or speeches.

Typically, after the search is performed, prospective hiring party user interface 160 would then display the list of job applicants by showing the prospective hiring party the matched job applicant's name, contact information, and a link to the portal view of the job applicant, but prospective hiring party user interface 160 can display the list of job applicants to the prospective hiring party in any other manner without departing from the scope of the present invention. In the embodiment where security interface 125 is activated, the link to the portal view of the job applicant may not be accessible without proper security clearance.

In one embodiment of the invention, prospective hiring party user interface 160 enables a prospective hiring party to specify how the matched job applicants are displayed.

In another embodiment, the prospective hiring party can specify his own portal view of the matched job applicants via a second selection of at least one data object. Prospective hiring party user interface 160 may then display the list of matched job applicants as a list of names, contact information, and a link to the prospective hiring party's customized portal. In this way, the prospective hiring party can target certain kinds of information to save time.

In still another embodiment, prospective hiring party user interface 160 can display a list of matched job applicants as a list of names, contact information, and the data objects of the second selection of at least one data object type. The prospective hiring party can then select job applicants that he prefers, and then select a third selection of at least one data object type to view another portal view. Typically, the next portal view encompasses a wider net of information than the previous, so that the prospective hiring party can read even more comprehensive information about the newly filtered job candidates, but the prospective hiring party can make any type of selection of data objects without departing from the scope of the present invention.

In another embodiment, system 100 saves search criteria and search results made by the prospective hiring party to revisit at a later time.

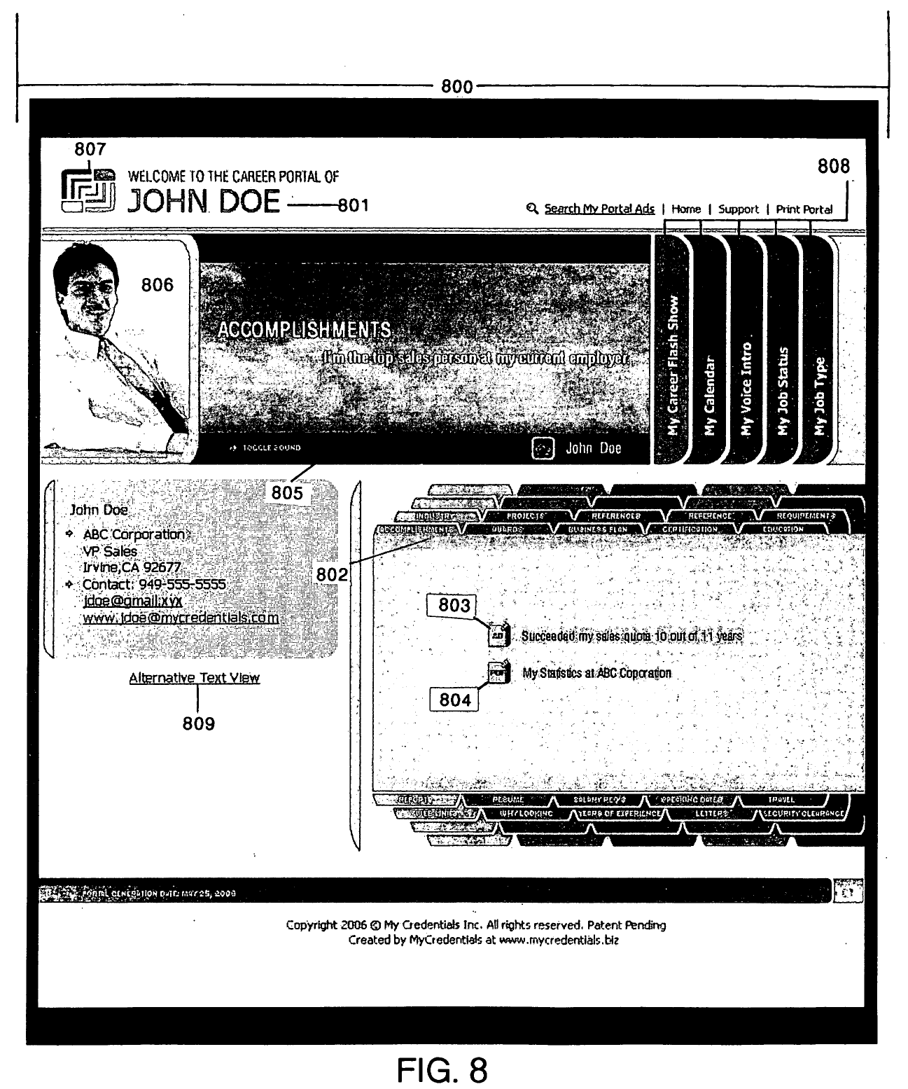

In another embodiment of the invention, prospective hiring party user interface 160 enables a prospective hiring party to browse through the data objects of a particular job applicant, or select at least one data object type to create an alternative portal view. For example, and in no way limiting the scope of the present invention, a prospective hiring party viewing an applicant's portal could choose to view a portal without images, such as an alternative text view of the portal (see discussion of link 809 in FIG. 8).

In another embodiment of the invention, prospective hiring party user interface 160 displays to a prospective hiring party at least one advertisement about a job applicant. This enables the job applicant to take a more proactive approach in advertising to a prospective hiring party via multimedia. The advertisement can be a video segment, audio segment, flash banner, text slideshow, or in any other media format without departing from the scope of the present invention. In an exemplary embodiment, the prospective hiring party can use the advertisement to access detailed information about the job applicant. For example and in no way limiting the scope of the present invention, the advertisement can be a URL link to a portal view created by the job applicant.

In another embodiment, job applicant user interface 130 and prospective hiring party user interface 150 is the same unit, such as a computer monitor and keyboard physically connected to server 110.

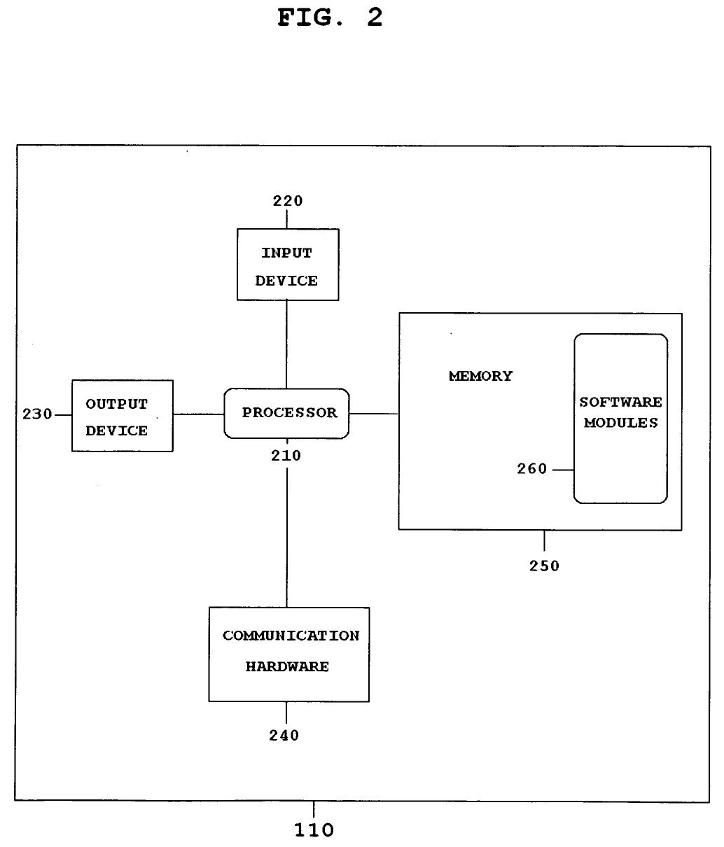

FIG. 2 illustrates an exemplary embodiment of server 110 as discussed in FIG. 1. This illustration shows the physical components of a server in accordance with the present invention. Each of the components is discussed in detail.

An exemplary embodiment of server 110 is shown in FIG. 2 with processor 210, input device 220, output device 230, communication hardware 240, memory module 250, and software modules 260. Server 110 comprises at least one input device 220, and at least one output device 230, utilized to create a user interface with which a server administrator can load software modules 260.

In one embodiment, memory module 250 is on a logically or physically separate disk than memory module 120, attached locally to the server or remotely through another means without departing from the scope of the present invention.

In another embodiment, memory module 250 and memory module 110 are one in the same, wherein both database 121 and software modules 260 reside on the same memory module.

Communication hardware 240 is typically an internal network jack built into server 110's motherboard but can likewise be a network card, a modem, a Bluetooth device, or any other device which allows bi-directional communication with another hardware device without departing from the scope of the present invention.

The major software modules 260 for system 100 are installed and loaded into memory module 250 accessible to server 110. These modules comprise: a module to provide a user interface; a module to assign UID and key to users; a module to store data into database 121; a module to provide search input; a module to receive search parameters; a module to perform searches; a module to generate and provide search results; a module to retrieve data objects; a module to create data objects; a module to edit data objects; a module to display data objects; and a module to update data. Software modules 260 interact with job applicant user interface 140 and prospective hiring party user interface 160. In an exemplary embodiment, software modules 260 create a website that job applicants and prospective hiring parties can access via the World Wide Web, which then dynamically creates job applicant user interface 140 and prospective hiring party user interface 160. Job applicant user interface 140 and prospective hiring party user interface 160 can then be used to execute software modules 260 on server 110, such as the module to perform searches.

FIG. 3 illustrates an embodiment of a database in accordance with the present invention with data object types 300-304, data repositories 310-312, and data object 320. Each of the columns 300, 301, 302, 303, and 304 contains a different data object type that can be stored in a data repository. Each of the rows 310, 311, and 312 in FIG. 3 refer to a different data repository, which corresponds to a different job applicant stored in the database. Data object type 300 refers to unique identifiers, which are used as a key to uniquely identify each data repository. An applicant's data repository contains at least one data object, one of which is identified as job applicant's data object 320, which together make up the credential information the applicant inputs into in the database and intends to present to prospective hiring parties.

In FIG. 3(a), the job applicant with unique identifier “JOHNDOE1” has selected a portal view displaying his programming expertise and earned certifications, targeting a programming job.

In FIG. 3(b), the job applicant with unique identifier “JOHNDOE1” has selected a portal view displaying business plans he has created, and his past management experience, targeting an upper management job. The business plans are represented as links to Adobe™ PDF files, but just as easily could display text or another graphical representation of the business plan.

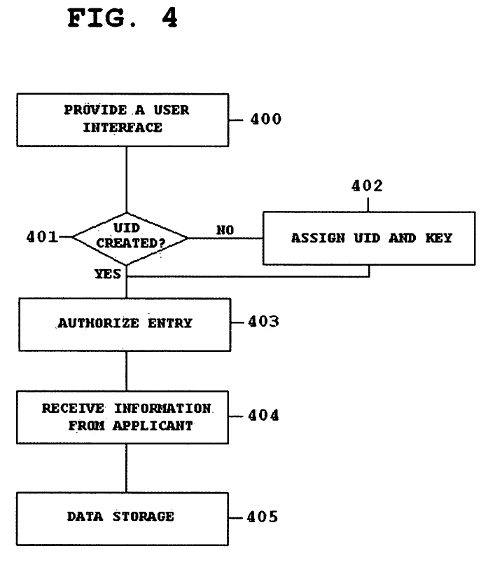

FIG. 4 is a flow chart illustrating a method for job applicant users to input and organize credential information in accordance with the present invention. In the illustrated embodiment, the six steps may be followed in the sequence shown, but the following steps may also be taken in a different sequence in order to achieve said task without departing from the scope of the present invention. This flow chart focuses on the steps the server takes to allow applicant users to input data and access data in the database.

In step 400 the server provides a user interface for a job applicant. A user interface may comprise one or more computers, gadgets, appliances, machines, mobile communication devices, software applications, or websites. The user interface can comprise any method of enabling bidirectional communication with a user without departing from the scope of the present invention.

In step 401 the job applicant determines whether or not he has a unique identifier (UID) and key. If the job applicant has previously obtained a unique identifier and key, the job applicant inputs the unique identifier and key into the user interface in step 403, and the server authenticates and authorizes entry. In one embodiment, this may be a username and password entered as part of a log-on process. The unique identifier and key can be any other type of security interface that limits access to the database provided by the server without departing from the scope of the present invention.

If an applicant user does not have a unique identifier and key, the server assigns a unique identifier and key to the job applicant in step 402. For example and in no way limiting the scope of the present invention, in the illustrated embodiment, the job applicant may be a new user, or the job applicant may wish to create a separate account. The job applicant can create this unique identifier and key and give it to the server for validation, or the server can provide one to the job applicant. Once the applicant is assigned a unique identifier and key, the applicant can then input the unique identifier and key into the user interface in step 403.

In step 403, the server receives the unique identifier and key combination from the job applicant. Depending on the unique identifier, the server will grant the job applicant access to a certain data repository. If the key does not match the unique identifier, the server will not grant access to the associated data repository.

In step 404, the server receives information from the job applicant via the provided user interface. The job applicant provides comprehensive information for input into the database. The server creates job applicant data objects in the database, and places the information given by the job applicant into corresponding data objects. In one embodiment, a data object is a category of information, which contains sub-data objects in which the applicant can input information. For example, and in no way limiting the scope of the invention, a data object can be a category of programming skills, and the sub-data objects can comprise programming languages, database familiarity, programming toolset familiarity, and program manager expertise. In another embodiment, the sub-data objects are not actually created within another data object, but are logically associated with the category data object.

In another embodiment, the applicant has an opportunity to input data from a variety of provided data objects. In yet another embodiment, the applicant can create or customize a data object to input data into. In an exemplary embodiment, the job applicant is required to provide information in at least one specified provided data object. Requiring a job applicant to provide information in a few specified job applicant data objects is desirable in order to achieve some common standard between all job applicants in the system.

In one embodiment, the job applicant creates at least one unique career portal using at least one data object in the job applicant data repository and sends the information to server. After the applicant concludes inputting credential information into the database, the hosting server, by way of the provided job applicant user interface, may prompt the job applicant to create a portal view by selecting and arranging a subset of job applicant data objects in the job applicant data repository. In one embodiment, the job applicant simply selects a subset of data objects in his data repository, which is published as his default portal view. In an exemplary embodiment, the job applicant can also arrange information elements in his portal view, so as to make it more aesthetically pleasing or to give higher priority to certain data objects over others.

The present invention introduces added career credentials that go beyond the traditional resume format that are not normally presented to potential hiring parties due to brevity constraints, and the fact that job applicants may not know what specific information potential hiring parties are interested in. Additionally, the career credentials were never organized into separable data objects that could be individually searched and displayed in customized portal views. In the present invention, each novel career credential is organized into a separate job applicant data object type.

In one embodiment of the invention, a data object in the database comprises a top job accomplishment the job applicant performed while working for a company. This data object can list the top job accomplishment, or milestone the job applicant performed, or can list a series of the top job accomplishments or milestones the job applicant performed at various companies, without departing from the scope of the present invention.

For example and in no way limiting the scope of the present invention, a listed job accomplishment could be the job applicant's successful sales over quota, large deals job applicant closed, increased sales directly due to job applicant's work, or generally how the job applicant helped increase productivity at the company job applicant worked for.

In another embodiment of the invention, a data object in the database comprises an award the job applicant received. An award comprises public recognition ceremonies, or any type of recognition earned while employed with a previous company. For example, and in no way limiting the scope of the present invention, an applicant may have Flash show, slide show, or an advertisement that displays his superior sales records with a previous employer.

In another embodiment of the invention, a data object comprises a membership organization that the job applicant has been a part of. Potential hiring parties can search and match results pertaining to an applicant's membership in order to determine compatibility, common interests, or simply to better understand the applicant's curriculum outside the workforce.

In one embodiment the membership organization comprises an association. An association can comprise a nation wide membership to a group of people that applicant has chosen to join for personal reasons. For example, and in no way limiting the scope of the present invention, an applicant may display his or her membership to the American Humane Association (AHA). A prospective hiring party searching for animal rights advocates might search and find this information desirable as a possible qualification.

In one embodiment the membership organization comprises a group. A group can comprise a local social group of people which the applicant socializes with on regular bases. For example, and in no way limiting the scope of the present invention, an applicant may display information about a local engineering club at the applicant's college or university in order to demonstrate career focus or hobby. A hiring party may find this desirable in a candidate for a particular position and search and access such groups throughout the database.

In one embodiment the membership organization comprises a board of directors. For example, and in no way limiting the scope of the present invention, an applicant who has been on the board of directors for a successful company may wish to make this fact about himself or herself available to prospective hiring parties. An advertisement of such an individual would be helpful to hiring parties that were looking for someone marketable to be part of their board of directors or similar position. Another example, and in no way limiting the scope of the present invention, applicant could include any specific roles and outcomes while holding particular positions and responsibilities as a board member. The applicant could place a picture of any plaques earned on his data repository and choose to make the picture searchable and accessible to prospective hiring users.

In another embodiment of the invention, a data object comprises a work authored by the job applicant. A work authored by the job applicant can comprise a business plan, a patent, a marketing strategy, a thesis, an article, a presentation, a speech, an industry publication, a book, a movie script, and a copyrighted work.

In one embodiment of the invention, a successful business or marketing plan comprises a strategy the job applicant created and successfully implemented. For example, and in no way limiting the scope of the present invention, an applicant may post an actual document of a business plan or marketing plan that applicant has successfully executed. Normally, a business plan is not submitted to a prospective hiring party due to its length and the fact that some companies might find it irrelevant. Prospective hiring parties looking for employees who have implemented a successful business plan may search and access a posted business plan to evaluate the applicant's ability and match with their needs.

In one embodiment of the invention, an invention the job applicant helped to patent comprises a patent number or a copy of a granted patent. For example, and in no way limiting the scope of the present invention, an applicant could post a number of patents on his career portal for others to view. Such information is not normally presented to a prospective hiring party. A prospective hiring party interested in hiring an engineer in a particular field for purposes of creating new technology can search the database for patents and access each patent to evaluate the qualifications of job applicants in the database that have patents in their career portals.

In one embodiment of the present invention an article comprises a column written by the job applicant for publication. For example and in no way limiting the scope of the invention, the article can be posted online, can be accessed through a link on the career portal, or can simply be referenced. In one embodiment of the invention, an industry publication is a music magazine the job applicant created and owns. His career portal can have a link to his magazines webpage. A prospective hiring party can review the article or industry publication and can have a better understanding of the job applicant's qualifications and experience.

In one embodiment of the present invention, a thesis comprises a paper the applicant wrote for a study at a university. Usually a thesis paper is not shown or submitted to a prospective hiring party because of its length. Thesis papers usually represent a detailed example of expository writing not found in other documents which gives insight to other talents the author possesses. A prospective hiring party who is interested in this job applicant may be able to access this thesis to analyze the job applicant's analytical and critical thinking skills, which may provide further insight into the applicant's credentials.

In one embodiment of the present invention, a presentation comprises a video or a PowerPoint presentation authored by the job applicant. In one embodiment of the present invention a speech is an audio file of a speech the job applicant prepared or delivered.

Due to the feasibility of delivering such multimedia presentations to a potential hiring party, multimedia presentations are usually never presented by a job applicant, or evaluated by a potential hiring party. Additionally, such presentations may only be of interest to a minority of potential hiring parties, and would therefore not normally be included in a resume meant to be distributed to a plurality of potential hiring parties. However, viewing a presentation may highlight to a prospective hiring party a set of skills that are otherwise not accurately conveyed through other means.

In one embodiment of the present invention, a speech comprises a speech that was either authored by the job applicant, delivered by the job applicant, or both. For example, an in no way limiting the scope of the invention, the job applicant can submit a video clip or an audio clip of himself delivering a speech in front of a live audience. Such a performance clip may give a prospective hiring party insight as to the job applicant's capability to deliver a speech and capture an audience. In another example, the job applicant can submit a text copy of a speech he authored, which may hive a prospective hiring party insight into the job applicant'

In one embodiment of the present invention, a copyrighted work is a book the applicant has written. Normally, copyrighted works are never submitted to potential hiring parties due to their length. Additionally, different hiring parties may be interested in different copyrighted works. A job applicant can include a plurality of copyrighted works from a variety of fields, organized by category, or importance, or in another manner without departing from the scope of the present invention. The potential hiring party can then peruse the different copyrighted works at their own leisure, possibly ignoring them altogether due to time constraints, or possibly reading one or more in its entirety to thoroughly analyze the job applicant's talent. Primarily however, this information further provides prospective hiring parties with deeper insight into the applicant's credentials.

In another embodiment of the present invention, a data object is a list of credential information regarding military history of the job applicant. Military history of the job applicant can comprise information pertaining to the branch of the U.S. armed forces in which applicant was part of, a military complex the where the job applicant was stationed, a special military training the applicant received, a military occupation specialty applicant has, or an applicant's level of security clearance.

In one embodiment of the present invention, a branch of the US armed forces comprises the Army, the Navy, the Air Force, or the Coast Guard. The job applicant may list which branch he or she was enlisted with. In one embodiment of the present invention, a military complex comprises a base located anywhere in the world in which the applicant has been stationed at in the past or present, or in which he or she expects to be stationed in the future. In one embodiment of the present invention, special military training applicant has received comprises any kind of unclassified programs the U.S. armed forces offers to members of the armed forces throughout the various branches. In one embodiment of the present invention, a military specialty occupation the applicant has comprises any occupation in which the applicant has particular experience and involvement. In one embodiment of the present invention, the applicant's level of security clearance comprises a certificate granted by the government.

An applicant's military history is normally not submitted to a prospective hiring party. Such history may be completely irrelevant to a job position the potential hiring party is looking for. On the other hand, certain potential hiring parties may wish to hire an employee with an extensive military background for a variety of reasons. For example and in no way limiting the scope of the invention, a potential hiring party may want an employee who can keep company secrets, and would find a job applicant with a history of high security clearance more attractive. Providing such military history in an easily searchable database provides potential hiring parties with access to this highly specific information without requiring potential hiring parties to read such extensive information if they deem it irrelevant.

In another embodiment of the present invention, a job applicant data object comprises a list of credential information regarding the applicant's immigration status. The job applicant's immigration status can comprise green card status, citizenship status, visa information, or citizenship.

In one embodiment of the present invention, green card status comprises the status an applicant as an immigrant to this country has obtained or will obtain in the future. In one embodiment of the present invention, an applicant's citizenship status comprises any information that pertains to his citizenship with either one or more countries. In one embodiment of the present invention, visa information comprises any types of visas the applicant may currently have or plan on obtaining or is requesting.

Immigration status is not normally a piece of information which is submitted to a prospective hiring party, much less is it a searchable field. Such information may be of great interest to prospective hiring parties. For example, and in no way limiting the scope of the invention, a prospective hiring party may not mind hiring a non-citizen, but may prefer non-citizens who have lived in the United States for a number of years.

In another embodiment of the present invention, a data object comprises a testimonial source associated with a job applicant. A testimonial source may comprise a recommendation letter, reference contact information, a news article written about the applicant, or a published quote by applicant.

In one embodiment of the present invention, a recommendation letter comprises any letter that as been written about the job applicant by anyone that has had any experience with the applicant. For example and in no way limiting the scope of the present invention, a letter of recommendation can be from a previous supervisor at a company, or from a professor who taught at a school the job applicant attended.

In one embodiment of the present invention, reference contact information comprises a list of phone numbers, addresses, e-mails, or websites which prospective hiring parties can use to contact people who are familiar with the job applicant.

In one embodiment of the present invention, a news article written about the applicant comprises at least one article in which the job applicant was featured in. For example, and in no way limiting the scope of the present invention, the job applicant's career portal comprises a link to a magazine article featuring the job applicant as the most successful salesperson for the year 2000.

In one embodiment of the present invention, a published quote said by applicant comprises at least one quote uttered by the job applicant which was published by another person.

Testimonials can come from a variety of sources, and normally are not extensively submitted to a potential hiring party in a convenient format. A job applicant may have a variety of testimonials from many different sources, but will not know how to present them, and, more importantly, would not know which potential hiring parties might show an interest in such testimonial sources. By allowing the job applicant to input as many testimonial sources that he wishes to list, and by allowing prospective hiring parties to search for testimonial sources only when they want to view such sources eases this burden of uncertainty and increases convenience for both parties.

In another embodiment of the present invention, a job applicant data object comprises a job project created or executed by the job applicant. A job project can comprise an industry event, a company created by the applicant, a construction project, a brokered deal, a defense project, a training method the applicant has implemented, or any project performed in a professional capacity.

In one embodiment of the present invention, an industry event comprises any event in any industry which was either created, executed, or directed by the job applicant.

In one embodiment of the present invention, a company created by the applicant comprises any company the applicant has founded himself or a company which the applicant has had a significant role in developing.

In one embodiment of the present invention, a construction project comprises any construction project for which the job applicant has done contracting work for.

In one embodiment of the present invention, a brokered deal comprises a deal which the job applicant participated in. For example and in no way limiting the scope of the invention, a job applicant could list a successful sale that he completed.

In one embodiment of the present invention, a training method comprises any method the applicant has either created, executed, or has used in the past to train others in a particular field.

For example and in no way limiting the scope of the present invention, a project performed in a professional capacity could be a project where the job applicant was required to build a large network of over 100 computers, or program a website for a young startup. A detailed description of such a project would be of interest to only a subset of potential hiring parties, and yet may be the one datum of experience a potential hiring party is looking for.

In another embodiment of the present invention, a job applicant data object comprises credential information on any specialized training the applicant has received. This includes at least an apprentice program, a certification, a license, and a workshop in which the applicant has successfully attended.

In one embodiment of the invention, an apprentice program comprises a successfully completed internship. In an exemplary embodiment of the invention, a job applicant would outline program specifics of the internship and list what tasks had been accomplished and what the applicant had gained from the experience. A prospective hiring party could not only glean what kinds of skills job applicant has learned, but could also glean the thoroughness of the type of training, and could potentially look up the qualities of the job applicant's mentor.

In another embodiment of the invention, a certification the job applicant has earned comprises a picture of a certificate. For example, and in no way limiting the scope of the present invention, an applicant may place an image or picture that demonstrates certification as a nurse assistant, or an emergency medical technician.

In one embodiment of the present invention, a license comprises any license that the job applicant may have obtained in any field. For example, and in no way limiting the scope of the present invention, an applicant may input a copy or PDF file of their bar license on their career portal. Prospective hiring parties interested in hiring attorneys may look at the attorney's license prior to an interview process.

In one embodiment of the present invention, a workshop an applicant has successfully attended comprises any seminar or convention that was attended for learning purposes. For example, and in no way limiting the scope of the present invention, a job applicant license as an attorney and looking to be hired as a litigator may desire to inform any prospective hiring party that he or she has attended a workshop in litigation practices. The information about the workshop may be either a list of workshops the applicant has attended, or he may have some documentation he received at the workshop, such as a certificate of completion, and post the certificate as a PDF file on his personal career portal.

In another embodiment of the present invention, a job applicant data object comprises a job ideal desired by the applicant. A job ideal can comprise a job benefit desired by the applicant; a minimal salary requirement; a location said user is willing to relocate to, a job duration, a job duty, a job position, and a job type the applicant desires to pursue.

In one embodiment of the present invention, a job benefit comprises any benefit the applicant requires or would like to receive from a prospective hiring party. For example, and in no way limiting the scope of the present invention, an applicant looking to receive particular 401 K benefits and stock options, might post these requirements on his portal to inform prospective hiring parties.

In one embodiment of the present invention, a minimal salary requirement comprises an amount of money applicant requires as compensation, or any other type of minimal compensation that a hiring party should consider providing if hiring the applicant.

In one embodiment of the present invention, a location applicant is willing to relocate comprises of at least one location to which applicant will either be able to relocate to or is unable to relocate to.

In one embodiment of the present invention, job duration comprises the length of time for which the applicant desires to work or any indication of how long the applicant will be available.

In one embodiment of the present invention, a job duty comprises any duty that the applicant desires to have assigned.

In one embodiment of the present invention, a job position comprises any position a job applicant desires, or is currently looking to obtain.

In one embodiment of the present invention, a job type comprises of any type of work the applicant desires to obtain.

In another embodiment of the present invention, a job applicant data object comprises an indicator of the job applicant's personality. An indicator of the job applicant's personality can comprise a picture of the applicant, an audio segment associated with the applicant, a video segment, a hobby applicant has, an interest, a description of why the applicant looking for a job, a website associated with said user, or a charity event associated with said user.

In one embodiment of the present invention, a picture of the applicant comprises either a JPEG or any other format of an image of himself that the applicant wishes to display. Even if looks play no part in a potential job, some potential hiring parties may be able to derive personality traits from a vapor of nuance. For example and in no way limiting the scope of the present invention, a potential hiring party may wish to hire job applicants with a certain look and feel to them.

In one embodiment of the present invention, a video segment comprises any video the applicant provides or desires to display on his career portal which is associated in any way with the applicant. For example, and in no way limiting the scope of the present invention, the video may be a video of the applicant speaking about his attributes and credentials. Prospective hiring parties might find it desirable to view an applicant's video in order to determine qualities such as character and personality.

In one embodiment of the present invention, a hobby comprises of any activity the applicant enjoys. In one embodiment of the present invention, an interest comprises any subject the applicant likes to study or talk about. Hobbies and interests may have no relevance to a job per se, but may have a great deal of relevance to office chemistry. For example and in no way limiting the scope of the invention, some potential hiring parties may want certain sections of the office to have similar hobbies and interests so their intra-office chemistry is improved. In another example, some potential hiring parties may want their salespeople to enjoy golf, as many sales are negotiated over a round during a weekend.

In one embodiment of the present invention, a description of why applicant is looking for a job comprises any comments an applicant makes with respect to why that applicant is looking for a job. For example, and in no way limiting the scope of the present invention, an applicant may have a statement prepared and display it on his portal. This statement would allow prospective hiring parties to view potential character traits and provide an insight into that applicant's reasons for leaving his or her last job. A prospective hiring party may desire to hire an applicant who has a particular goal in mind rather than an applicant who simply desires a change in location and career.

In one embodiment of the present invention, a website associated with an applicant comprises any website on the internet in which the applicant has been mentioned, or in which the applicant has worked on, or any website that represents any interest the applicant may wish to share with prospective employers.

In one embodiment of the present invention, a charity event the job applicant sponsored or was a part comprises any event that was executed for purposes of raising funds for any purpose. For example, and in no way limiting the scope of the present invention, this could include fundraisers applicant has organized or has been a part of and which he or she desires to display in their portal.

In another embodiment of the invention, a job applicant data object in the database is a list of at least one key client the job applicant worked with. For example, and in no way limiting the scope of the present invention, an applicant that has worked for clients such as IBM, Oracle, and Microsoft, may want to display a list of those clients that applicant did work for. Prospective hiring parties looking to hire an applicant for a particular task (i.e. sales) would be interested to see what type of clients this applicant has provided his or her services for. Such background experience could be important if the potential hiring party currently deals with, or would like to deal with, those clients, or similar clients.

In another embodiment of the invention, a job applicant data object in the database is a list of at least one description of an apprentice the job applicant mentored. For example, and in no way limiting the scope of the present invention, an applicant may find it desirable to display the names of some of the people he or she has mentored and helped become successful. Again, this type of information is desirable to prospective hiring users and serves as self marketing purposes for the applicant.

The job applicant data objects may be inputted and stored in a variety of forms. A job applicant data object may be in the form of simple text, of a proprietary document format such as Microsoft™ word or Adobe™ PDF, a Flash presentation, a Shockwave presentation, an audio file, a video file, or in any other format that can be stored in an electronic database and distributed via a computer user interface.

For example and in no way limiting the scope of the present invention, an applicant may choose to upload an Adobe™ PDF document into a data object describing all the special military training the job applicant received, while he chose to upload an audio file into a data object describing speeches the job applicant had given.

In an exemplary embodiment of the present invention, the job applicant can also create a customized job applicant data object. In one embodiment, the job applicant is able to create a customized job applicant data object that is a category of customized job applicant data objects, and can then create customized job applicant data objects under that umbrella category.

For example and in no way limiting the scope of the present invention, an applicant may create a category data object “Fun Portfolio.” The applicant can then create three new customized job applicant data objects within the “Fun Portfolio” data object, labeled “Photos,” “Videos,” and “Slideshows.” The job applicant is then able to input videos, photos, and slideshows into each custom data object, and can then place each of these data objects in a portal view which the job applicant believes would be of interest to a particular type of prospective hiring party.

In an exemplary embodiment, the hosting server prompts the job applicant to create a data object, wherein the data object is a personal advertisement. This advertisement can be displayed to prospective hiring parties and other applicants through the system and may be displayed to even non-registered users of the system without departing the scope of the present system. The viewer of a job applicant's advertisement should be able to use the advertisement to view the contents of at least one job applicant data object in the job applicant's job applicant data repository. In one embodiment, the advertisement provides a link so that when a viewer activates the link, the viewer of the advertisement has access to a portal view of the job applicant.

The format of the advertisement may be a video segment, an audio segment, a flash show, a flash banner, a text slideshow, a picture or image slideshow, or any other format available to create an advertisement without departing from the scope of the invention.

In another exemplary embodiment, the hosting server prompts the job applicant to create a data object, wherein the data object is a scheduling device that displays the job applicant's availability for certain events. For example and in no way limiting the scope of the present invention, the scheduling device could be a calendar that displays the job applicant's availability for interviews and jobs. In an exemplary embodiment, the scheduling device allows the job applicant to enter information pertaining to job availability, interview availability, and scheduling availability.

In step 405, the server saves the data input by the job applicant on a database, and the data remains stored to be retrieved by authorized users at any time access can be provided and obtained. Later, the applicant may go back to stage 402 and edit any data entered by applicant at any time by utilizing the unique identifier and key assigned to the job applicant in step 402.

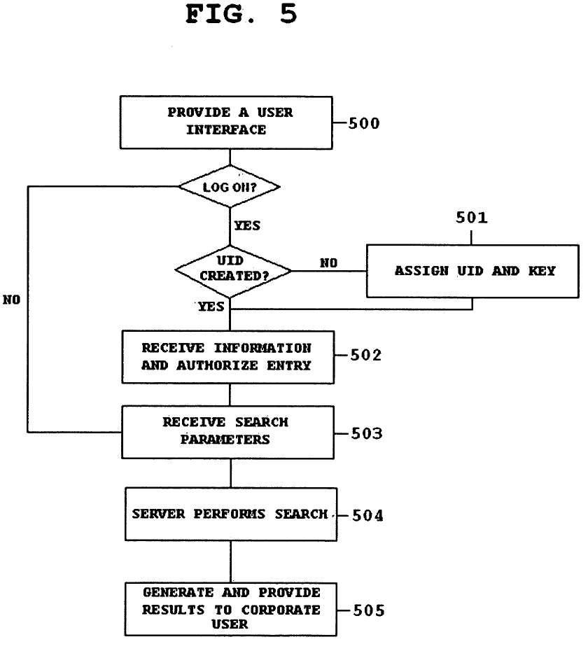

FIG. 5 is a flow chart illustrating a method for prospective hiring parties to access information about applicants from a database in accordance with the present invention. This illustration focuses on the steps necessary for a server to allow prospective hiring party users access to the database, in order to search and retrieve applicant information stored.

FIG. 5 illustrates seven steps that are may be followed in the sequence shown, but the steps may also be taken in several different sequences in order to achieve said task without departing from the scope of the present invention.

In step 500 the server provides a user interface for a prospective hiring party. As mentioned above in FIG. 4, a user interface may comprise one or more computers, gadgets, appliances, machines, mobile communication devices, software applications, or websites.

The server may either wait for the user to log on to the system or may simply allow accessing users to search the database, thus skipping steps 501 and 502.

For example, and in no way limiting the scope of the present invention, the server may choose to allow users (e.g. hiring managers, recruiters, prospective hiring parties) to access the database at any time without a need to log on or pay memberships which would require the UID and key. In such embodiment however, the prospective hiring party would not be able to have contact information stored and accessible to applicant users.

In another exemplary embodiment, and in no way limiting the scope of the present invention, the server might either require or give the choice to prospective hiring parties to setup a UID and key in order to keep a record of their business or simply to restrict access depending on membership status or any other reason.

If the server requires prospective hiring parties to have a UID, then the server assigns a UID and key, discussed below at step 501, or simply receive the information and authorize access in step 502.

In step 501, the server assigns a unique identifier and key to the prospective hiring party. This provides access to those users that do not already have a UID and key. The prospective hiring party can create this unique identifier and key and give it to the server for validation, or the server can provide one. In one embodiment, this may be a username and password inputted as part of a log-on process. The unique identifier/key creation can be any other type of security interface that limits access to the database provided by the server without departing from the scope of the present invention. Step 501 is therefore unnecessary for those users who already have a UID/key for example already existing users.

In step 502 the prospective hiring party user accesses the server through the provided user interface. The prospective hiring party is prompted to provide the server with data objects such as information pertaining to user's business, such as contact information, name of corporation or business or any other information that identifies the user in some way. Also in step 502, the prospective hiring party inputs data objects pertaining to access options.

In an exemplary embodiment, the prospective hiring party is prompted to input or enter their contact information including their name and address, and type of membership options (which provide different levels of access to the database provided by server). Following said data input, in an exemplary embodiment, the prospective hiring party is authorized access to the database after server receives payment.

In step 503 the server prompts the prospective hiring party to input data objects or information pertaining to desired job applicants that may be matched with data objects found in the database. Prospective hiring parties may choose several data object types or only one data object type.

In an exemplary embodiment, a prospective hiring party is prompted to input searchable data objects including advertisements, slideshows, or any other data that may be provided by job applicants. The searchable data objects and data object types are discussed above in FIG. 3.

In step 504 the actual search is performed by the server. In an exemplary embodiment the search is completed by way of a Boolean search, but this search may be completed in any other manner in which a server chooses to perform this task.

Once the search has been fully generated and data objects searched are matched with data objects stored in database, server provides the results in 505.

In an exemplary embodiment, the provided results at step 505 are lists of matches either of data object types or data objects. In another exemplary embodiment, a prospective hiring party is provided with different possible types of search results which they have selected at step 503. The results may be based on a search of different types of applicant advertisements; a search may be conducted on one or more particular unique identifiers; a search may be conducted of one or more data object types; or any other data objects or data object types or combination of the above mentioned searchable kinds of data.

Additionally, in an exemplary embodiment, and in no way limiting the scope of the present invention, a potential employer may choose the way in which he or she will view the results of the search parameters of data objects or data object types that user has provided server. The results provided may be a list of applicant advertisements, applicant UID's, applicant data object types, or a list of applicant published works.

For example and in no way limiting the scope of the present invention, a potential employer or prospective hiring party may access an applicant's data by performing a search of advertisements that include information regarding a particular field or profession. The server performs the search parameters potential employer inputs and provides employer with a list of links to advertisements potential employer may view. These may be banners with links, or flash shows, or videos or audible files or any other type of advertisement that links the potential employer directly to their respective applicant portal. A potential employer may choose a link and retrieve applicant information.

Another example, and in no way limiting the scope of the present invention, a potential employer or prospective hiring party may access an applicant's data by performing a search of data object types such as the ones described and discussed in FIG. 3. FIG. 3 includes the data object types 301, 302, 303, and 304. Respectively these are labeled “Programming,” Business Plans,” “Management,” and “Certifications.” By searching these object types, the potential employer or prospective hiring party provides these object types as parameters and the server in turn provides that user with a result list of matching applicants who have chosen these particular object types in their repository. The list may be a list of UID's which could be in the form of full names or usernames or any other kind of identifier that links the information found by the search to a particular applicant portal. A prospective hiring party may choose a link and retrieve the corresponding applicant's information.

Additionally, the results of the search may be displayed as pictures or images of the different applicants who have matching information to that information which was searched. These pictures could additionally have links to each applicant's portal. A potential employer may ‘click’ or choose one of the pictures displayed and retrieve that applicant's information. A prospective hiring party might want to display the results in this manner in order to look for applicants with a particular appearance or presence. Images can provide prospective hiring parties with more insight into an applicant's potential character and demeanor.

Another example, and in no way limiting the scope of the present invention, the results may include other links (not just to applicant portals) including applicant websites hosted by server, or other internet websites which have information on a particular applicant such as a news article in which an applicant is featured in. A potential employer may choose a link and retrieve the address to a website or be linked directly to that website where potential employer may read the article in which the applicant has been featured.

Additionally, and in no way limiting the scope of the present invention, the results may be in the form of a list of PDF files, such as published works by applicant's on the system, portfolios applicants may have put together, a certificate, or any other type of document an applicant has placed on the database for viewing by prospective hiring parties or potential employers. By way of example, and in no way limiting the scope of the present invention, the applicant interested in a programming job may have made available a certificate as a PDF file (see FIGS. 3, 3(a), and 3(b). A prospective hiring party's search results for data object type “Certifications” 304 may return results that include applicant JSMITH23 data objects 320, matching the data object type requested by the potential employer. A potential employer may then choose a link and retrieve a PDF copy of applicant JSMMITH23's certification as a Microsoft Office Specialist.

Additionally, and in no way limiting the scope of the present invention, in an exemplary embodiment, the list results contain links to each job applicant's “Career Portal” or portal view, as illustrated below in FIG. 8.

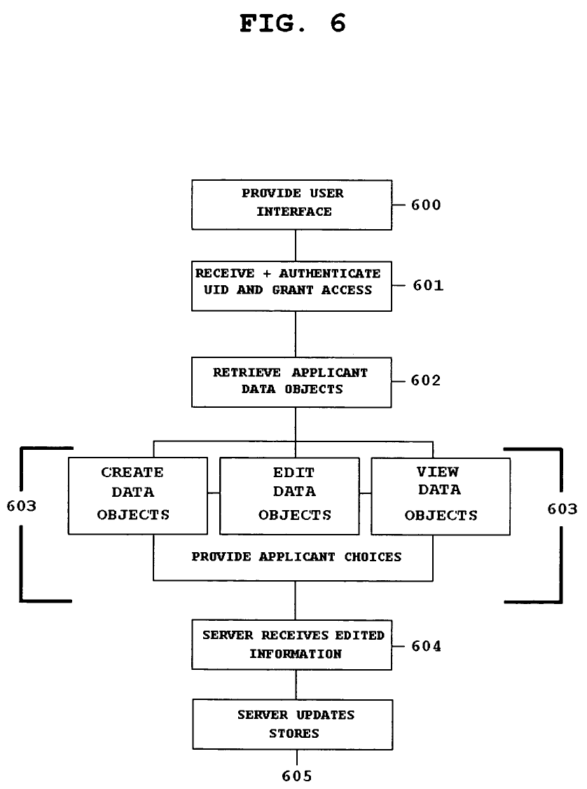

Turning next to FIG. 6, this flow chart illustrates six steps that may be followed in the sequence shown, but as any ordinary person skilled in the art of the present invention would recognize, the following steps may also be taken in several different sequences in order to achieve said task. FIG. 6 is a step by step flow chart of how the server provides applicant users a means to create, edit or view their own data.

In step 600 the server provides a user interface design. As mentioned above in FIG. 4, a user interface may be one or multiple computers, gadgets, appliances, machines, mobile communication devices, software applications, or websites.

In step 601, the applicant inputs the unique identifier and key that was provided in step 401 of FIG. 4. As discussed in reference to FIG. 4 above, a unique identifier may be a username and password or any other type of identification and key system that provides only authorized access to the database provided by the server. Once the unique identifier and key are received and authenticated, the server grants access to the applicant.

In step 602, the applicant's data objects are retrieved from the database discussed in FIG. 3.

In step 603 different options may be chosen by the applicant in deciding whether to edit existing data objects, create new data objects or simply view data objects in that applicant's reservoir. The applicant may also choose a combination of these options and in any order.

In step 604 applicant sends any information that applicant has created or edited and server receives the information to store in the database.

In step 605, the server updates any information that was changed in step 603. If no information was changed in any way, the applicant may simply exit the user interface and the data retrieved by server is returned to database for continued storage.

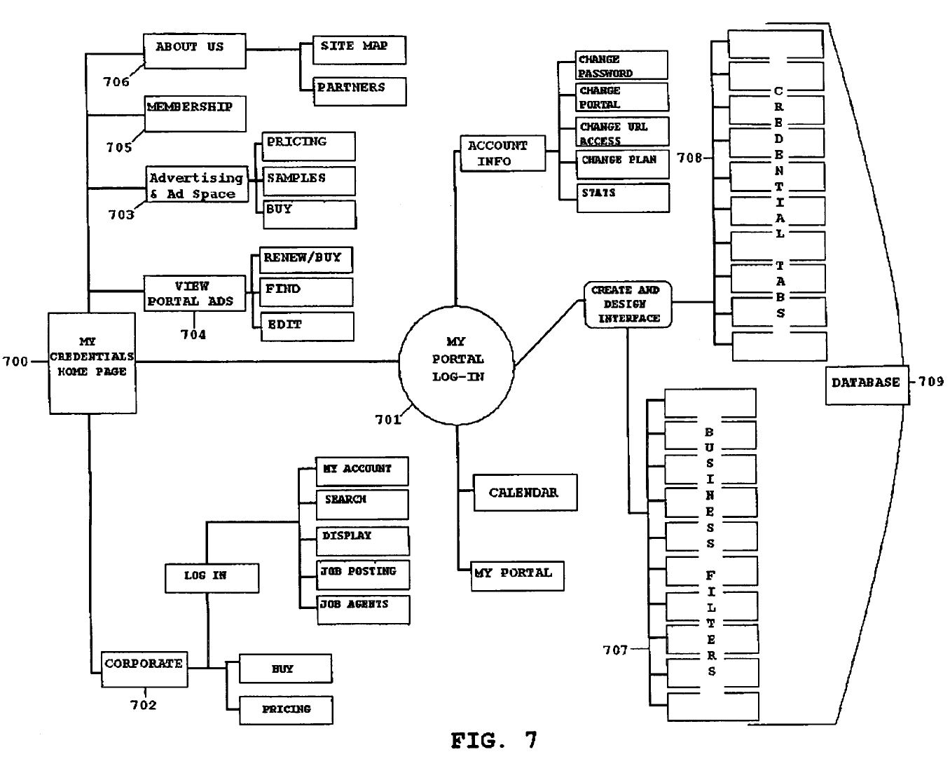

In an exemplary embodiment of the present invention, a job applicant using a user interface such as a computer, may access the network via internet and log in using his or her username and password to a website such as the one illustrated in FIG. 7 and FIG. 8. Once access to the database is granted, the server retrieves the applicant's information and applicant is prompted to create, edit or view any data object on that user's data repository.

For example, and in no way limiting the scope of the present invention, an applicant may choose to edit a video or edit an advertisement or upload a new resume, certification document, immigration document, or any other type of information that may be useful or desirable for that applicant to store on the database.

Once the applicant has made any changes to the data objects or created new ones, or is finished viewing the data retrieved, the information in the applicant's reservoir is updated and stored back in the database.

FIG. 7 illustrates an exemplary embodiment of a site map to a website provided by the server. The main components of this exemplary site are: home page 700; job applicant log-in link 701; Prospective hiring party, here labeled “Corporate” log-in link 702; Advertising and Ad space link 703; Viewable portals link 704;

The illustration shows home page 700 provides the entrance and access to the entire network.

Link 701 leads candidates directly to their personal portals for editing viewing or creating purposes. Within each portal a candidate client can create, edit and view their different personalized data object types, labeled here as business filters 707. Similarly, each candidate member may create, edit and view their personalized data objects and data object types 708 in order to implement their most recent information each applicant desires to place for viewing and or making accessible to potential employers. The whole system is stored in a large database 709, described in greater detail above (see FIG. 1) searchable by prospective hiring parties and applicant members.

Prospective hiring party, here labeled “Corporate”, may sign-in and membership purchasing is accessed through link 702. Link 702 provides access to a search engine for prospective hiring parties to search the database 710.

Link 703 allows any visitor or member to view ads currently circulating throughout the network.

Link 704 allows quick access to client candidate's advertising ads for viewing or for editing. Here, candidate members may stop the running of ads, renew their ads or purchase other ads.

Links 705 provide visitors and existing members with various options to either change pricing plans, review the terms of using the network, general information about the network, help using the network, and FAQ information for further assistance or inquiry regarding this system.

Links 706 allow visitors new to the site to look at samples of different features of the site including portals and flash shows, and provide information regarding the site and affiliated individuals.

Finally turning to FIG. 8, an exemplary embodiment of a portal view displaying applicant John Doe's data repository is illustrated.

In an exemplary embodiment, and in no way limiting the scope of the present invention, a portal view of a job applicant is shown in FIG. 8 in a website format, displaying webpage 800, with job applicant name 801. Data object types discussed in FIG. 3 are displayed as browsing tabs 802, job applicant advertisement 803, and job applicant sales quota statistic document 804. In this exemplary portal view, the selected job applicant data types are shown as job applicant advertisement 803, and job applicant sales quota statistic document 804. The prospective hiring party can easily browse through the different job applicant data objects via browsing tabs 802. At the top of the page, the job applicant's name 801 is listed next to links 808 to other data objects created by the job applicant that a prospective hiring party might be interested in.

For example, and in no way limiting the scope of the present invention, a prospective hiring party or potential employer can access this exemplary webpage or Career Portal, by using the methods discussed above, including setting search parameters, receiving the search results, retrieving the information (retrieved by server) and choosing information retrieved to be displayed.

A potential employer that might have picked the applicant John Doe, would have chosen to display the webpage illustrated in FIG. 8. A potential employer may click on the links displayed as folder tabs in order to reveal further information about John Doe.

Instead of being limited to the format of a traditional resume, or relay only on information available on a personal webpage, the potential employer is supplied with various tools to give him or her insight into what John Doe has accomplished, or what awards he might have, or what type of work experience he has gained. In an exemplary embodiment, John Doe is able to provide potential employers with expansive documents, lifestyle choices (e.g. membership organizations or military history) and a multitude of factors, each reflected by the types of tabs displayed on the Career Portal, all of which allow a potential employer to intake and retain far more information than possible through the resume format traditionally used.

A potential employer who has accessed John Doe's Career Portal 800, is further informed and engaged by advertisements 803, flash shows 805, personal portrait 806, logo 807, and even video or audible demos, all available by simply clicking on the desired link, advertisement, banner, etc.

In another embodiment of the present invention, above, each portal may be viewed by prospective hiring parties in alternative ways. Alternate text view link 809, allows the portal to be displayed as a text only webpage, making the site more versatile and adaptable to different preferences.

In summary, the present invention provides a system and method for organizing job applicant data that completely expands the scope and reach of a traditional resume. And as discussed above (see FIG. 6), Career Portal 800 may be edited at any time.

Additionally each applicant may display all or part of their information (as discussed above under FIG. 3). Career Portal 800 could display tabs 802 for some hiring agents or potential employers, and hide them to other potential employers depending on what applicant John Doe desires to display.

The broad scope of credential information made available through this system and the versatility that this system allows, makes an applicant's information available in many different formats and customized views, targeting different interests simultaneously, which makes this novel system more efficient, accurate and desirable to job candidates, hiring managers or potential employers, and any one interested in making themselves a more competitive, and marketable individual.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A method of receiving credential information of a user for consideration by a prospective hiring party, comprising:
providing an user interface to receive credential information comprising an association said user is a member of, a board of directors said user sits on, a business plan authored by said user, a marketing strategy authored by said user, a patent invented by said user, an article authored by said user, a thesis authored by said user, a presentation authored by said user, a speech authored by said user, a speech delivered by said user, an industry publication authored by said user, a copyrighted work authored by said user, a branch of the United States armed forces said user worked under, a military complex said user was stationed, special military training said user received, a military occupation specialty said user has, said user's level of security clearance, said user's green card status, said user's visa information, a recommendation letter written about said user, reference contact information of a person who knows said user, a news article written about said user, a published quote of said user, an industry event said user participated at, a company created by said user, a construction project said user participated in, a brokered deal said user helped negotiate, a training class said user taught, a mentorship program said user taught, an apprentice program said user participated in, a certification said user earned, a license said user earned, a workshop said user participated in, a job benefit said user wants, a minimal salary requirement said user wants, a location said user is willing to relocate to, a job duration said user wants, a job duty said user wants, a job position said user wants, a job type said user wants, a picture of said user, an audio segment associated with said user, a video segment associated with said user, a hobby of said user, an interest of said user, a description of why said user is looking for a job, a website associated with said user, a charity event associated with said user, an advertisement associated with said user, and a schedule associated with said user;
receiving said credential information from said user;
creating a data repository comprising said credential information; and
making contents of said data repository perceptible upon request to said prospective hiring party.

2. A method of receiving credential information of a user for consideration by a prospective hiring party, comprising:
providing a first user interface to receive credential information from said user;
receiving said credential information from said user;
creating a data repository for said user comprising said credential information;
providing a second user interface to receive information related to a first selected subset of said credential information from said user;
making perceptible via said second user interface said first selected subset of credential information to said prospective hiring party without making perceptible via said second user interface a first unselected subset of said credential information to said prospective hiring party;
providing a security interface which, when activated by said user, prohibits a non-privileged user from accessing said selected subset of credential information;
providing a third user interface to receive information related to a second selected subset of said credential information from said prospective hiring party;
making perceptible via said third user interface said second selected subset of credential information to said prospective hiring party without making perceptible via said third user interface a second unselected subset of said credential information to said prospective hiring party; and
making perceptible via a fourth user interface said credential information to said prospective hiring party, wherein at least one data object in said data repository is stored in an operating system independent format.

3. A method of receiving credential information of a user for consideration by a prospective hiring party, comprising:
providing an user interface to receive credential information comprising a membership organization that said user is a member of;
receiving said credential information from said user;
creating a data repository comprising said credential information; and
making contents of said data repository perceptible upon request to said prospective hiring party.

4. The method of claim 3, wherein said membership organization is selected from a group consisting of an association, a group, and a board of directors.

5. A method of receiving credential information of a user for consideration by a prospective hiring party, comprising:
providing an user interface to receive credential information comprising a work authored by said user;
receiving said credential information from said user;
creating a data repository comprising said credential information; and
making contents of said data repository perceptible upon request to said prospective hiring party.

6. The method of claim 5, wherein said work authored by said user is selected from a group consisting of a business plan, a marketing strategy, a patent, an article, a thesis, a presentation, a speech, an industry publication, a book, a movie script, and a copyrighted work.

7. A method of receiving credential information of a user for consideration by a prospective hiring party, comprising:
providing an user interface to receive credential information comprising military history information about said user;
receiving said credential information from said user;
creating a data repository comprising said credential information; and
making contents of said data repository perceptible upon request to said prospective hiring party.

8. The method of claim 7, wherein said military history information is selected from a group consisting of a branch of the United States armed forces, a military complex said user was stationed, special military training said user received, a military occupation specialty said user has, and said user's level of security clearance.

9. A method of receiving credential information of a user for consideration by a prospective hiring party, comprising:
providing an user interface to receive credential information comprising immigration status of said user;
receiving said credential information from said user;
creating a data repository comprising said credential information; and
making contents of said data repository perceptible upon request to said prospective hiring party.

10. The method of claim 9, wherein said immigration status is selected from a group consisting of green card status, citizenship status, and visa information.

11. A method of receiving credential information of a user for consideration by a prospective hiring party, comprising:
providing an user interface to receive credential information comprising a testimonial source;
receiving said credential information from said user;
creating a data repository comprising said credential information; and
making contents of said data repository perceptible upon request to said prospective hiring party.

12. The method of claim 11, wherein said testimonial source is selected from a group consisting of a recommendation letter, reference contact information, a news article written about said user, and a published quote of said user.

13. A method of receiving credential information of a user for consideration by a prospective hiring party, comprising:
providing an user interface to receive credential information comprising a job project;
receiving said credential information from said user;
creating a data repository comprising said credential information; and
making contents of said data repository perceptible upon request to said prospective hiring party.

14. The method of claim 13, wherein said job project is selected from a group consisting of an industry event, a company created by said user, a construction project, a brokered deal, a defense project, and a training method.

15. A method of receiving credential information of a user for consideration by a prospective hiring party, comprising:
providing an user interface to receive credential information comprising specialized training said user received;
receiving said credential information from said user;
creating a data repository comprising said credential information; and
making contents of said data repository perceptible upon request to said prospective hiring party.

16. The method of claim 15, wherein said specialized training is selected from a group consisting of an apprentice program, a certification, a license, and a workshop.

17. A method of receiving credential information of a user for consideration by a prospective hiring party, comprising:
providing an user interface to receive credential information comprising a job ideal;
receiving said credential information from said user;
creating a data repository comprising said credential information; and
making contents of said data repository perceptible upon request to said prospective hiring party.

18. The method of claim 17, wherein said job ideal is selected from a group consisting of a job benefit, a minimal salary requirement, a location said user is willing to relocate to, a job duration, a job duty, a job position, and a job type.

19. A method of receiving credential information of a user for consideration by a prospective hiring party, comprising:
providing an user interface to receive credential information comprising an indicator of said user's personality;
receiving said credential information from said user;
creating a data repository comprising said credential information; and
making contents of said data repository perceptible upon request to said prospective hiring party.

20. The method of claim 19, wherein said indicator of said user's personality is selected from a group consisting of a picture of said user, an audio segment associated with said user, a video segment associated with said user, a hobby of said user, an interest of said user, a description of why said user is looking for a job, a website associated with said user, and a charity event associated with said user.

21. A method of receiving credential information of a user for consideration by a prospective hiring party, comprising:
providing a first user interface to receive from said user an advertisement associated with said user;
receiving said advertisement associated with said user;
creating a data object comprising said advertisement; and
making perceptible said advertisement to said prospective hiring party.

22. The method of claim 21, further comprising:
providing a second user interface to receive credential information from said user;
receiving credential information from said user;
creating a data repository comprising said credential information; and
making contents of said data repository perceptible upon request to said prospective hiring party.

23. The method of claim 22, wherein said advertisement comprises a video segment.

24. The method of claim 22, wherein said advertisement comprises an audio segment.

25. The method of claim 22, wherein said advertisement comprises a flash banner.

26. A method of receiving credential information of a user for consideration by a prospective hiring party, comprising:
providing a first user interface to receive a schedule of said user's interview availability;
receiving said schedule from said user;
creating a data object comprising said schedule;
making perceptible said schedule to said prospective hiring party; and
providing a user interface to enable said prospective hiring party to schedule an interview with said user;

27. The method of claim 26, further comprising providing a bidirectional communication interface enabling said prospective hiring party to conduct an interview with said user.

28. The method of claim 25, wherein said bidirectional communication interface comprises a live video conference.

29. The method of claim 25, wherein said bidirectional communication interface comprises a live instant messaging conference.

30. The method of claim 25, wherein said bidirectional communication interface comprises a live audio conference.

31. A method of receiving credential information of a user for consideration by a prospective hiring party, comprising:
providing a first user interface to receive credential information from said user;
receiving said credential information from said user;
creating a data repository for said user comprising said credential information;
providing a second user interface to customize presentation of said credential information; and
making perceptible said customized presentation of said credential information to said hiring party.

32. The method of claim 31, further comprising providing a security interface which, when activated by said user, prohibits a non-privileged user from accessing said selected subset of credential information.

33. The method of claim 32, wherein at least one data object in said data repository is stored in an operating system independent format.

34. The method of claim 33, wherein said operating system independent format is a Portable Document Format (PDF).

35. The method of claim 33, wherein said operating system independent format is a Flash presentation.

36. The method of claim 33, wherein said operating system independent format is a Shockwave presentation.

37. The method of claim 33, wherein said operating system independent format is a text document.

38. A system of receiving credential information of a user for consideration by a prospective hiring party comprising:
a server;
a memory module accessible by said server;
a database, residing on said memory module, comprising a data repository for each user stored in said system, wherein each data repository comprises a unique identifier and at least one data object;
a first user interface for:
enabling said user to input credential information into data objects within a data repository, and
enabling said user to customize a presentation of said credential information;
a first communication link connecting said server to said first user interface;
a second user interface for making perceptible said presentation of credential information to said prospective hiring party; and
a second communication link connecting said server to said second user interface.

39. The system of claim 38, wherein said second user interface is also used for:
enabling said prospective hiring party to input search criteria for said credential information; and
making perceptible said presentation to said prospective hiring party.

40. The system of claim 39 further comprising a security interface which, when enabled by said user, prohibits a non-privileged user of said system from viewing a customized portal view.

41. A computer-readable medium carrying one or more sequences of instructions for receiving credential information of a user for consideration by a prospective hiring party, wherein execution of said one or more sequences of instructions by one or more processors causes said one or more processors to:
provide a first user interface to receive information related to a category of credential information selected from a plurality of different categories of credential information;
in response to receiving said information related to said selected category of credential information, provide a second user interface to receive credential information associated with said category from said user;
receive said credential information associated with said selected category from said user; and
create a data object pertaining to said user comprising said credential information associated with said category of credential information.
